(19) United States
(12) Patent Application Publication
(10) Pub. No.: US 2015/0095088 A1
(43) Pub. Date: Apr. 2, 2015

(54) APPOINTMENT SCHEDULERS WITHIN SPONSORED CONTENT ITEMS

(71) Applicant: Google Inc., Mountain View, CA (US)

(72) Inventors: Lakshmi Kumar Dabbiru, Mountain View, CA (US); Tengfei Mu, Mountain View, CA (US)

(73) Assignee: Google Inc., Mountain View, CA (US)

(21) Appl. No.: 14/041,420

(22) Filed: Sep. 30, 2013

(51) Int. Cl. G06Q 10/10; G06Q 30/02

(52) U.S. Cl. CPC G06Q 10/1095; G06Q 30/0277
USPC 705/7.19

(57) ABSTRACT

This specification describes methods, systems, and apparatus, including computer programs encoded on a computer-readable storage device, for providing a content item. The subject matter of the specification is embodied in a method that includes providing, from a processing device, data that causes a display of a sponsored content item on a client device. The display of the sponsored content item includes a control for scheduling an appointment, and the control, responsive to an input, causes a display of a form within the content item for receiving user-input related to scheduling the appointment. The method also includes receiving, at the one or more processing devices, information representing the user-input related to scheduling the appointment, and providing the information representing the user-input to a computing device associated with scheduling appointments related to the sponsored content item. The information is used by the computing device to schedule the appointment.

### BACKGROUND

This specification relates to information presentation.

The Internet provides access to a wide variety of resources. For example, video, audio, and Web pages are accessible over the Internet. These resources present opportunities for other content (e.g., advertisements, or “ads”) to be provided along with the resources. For example, a Web page can include slots in which ads can be presented. The slots can be allocated to content providers (e.g., advertisers) based on an auction in which content providers can provide bids specifying amounts that the content providers are willing to pay for presentation of their content.

### SUMMARY

In general, in one aspect, a method performed by one or more processing devices includes providing, from the one or more processing devices, data that causes a display of a sponsored content item on a client device. The sponsored content item can be provided from a pool of sponsored content items in response to a request for content received from the client device. The display of the sponsored content item includes a control for scheduling an appointment, and the control, responsive to an input, causes a display of a form within the content item for receiving user-input related to scheduling the appointment. The method also includes receiving, at the one or more processing devices, information representing the user-input related to scheduling the appointment, and providing the information representing the user-input to a computing device associated with scheduling appointments related to the sponsored content item. The information is used by the computing device to schedule the appointment.

In another aspect, this document describes a system that includes a content management and delivery engine (also referred to as a content management and delivery system) and a storage device in communication with the content management and delivery engine. The content management and delivery engine includes one or more processors and is configured to provide data that causes a display of a sponsored content item on a client device. The sponsored content item can be provided from a pool of sponsored content items in response to a request for content received from the client device. The display of the sponsored content item includes a control for scheduling an appointment, and the control, responsive to an input, causes a display of a form within the content item for receiving user-input related to scheduling the appointment. The content management and delivery system is also configured to receive information representing the user-input related to scheduling the appointment, and provide the information representing the user-input to a computing device associated with scheduling appointments related to the sponsored content item. The information is used by the computing device to schedule the appointment. The storage device is configured to store the pool of sponsored content items.

In another aspect, this document describes a computer-readable storage device having encoded thereon computer readable instructions configured to cause one or more processors to perform various operations. The operations include providing data that causes a display of a sponsored content item on a client device. The sponsored content item can be provided from a pool of sponsored content items in response to a request for content received from the client device. The display of the sponsored content item includes a control for scheduling an appointment, and the control, responsive to an input, causes a display of a form within the content item for receiving user-input related to scheduling the appointment. The operations also include receiving, at the one or more processing devices, information representing the user-input related to scheduling the appointment, and providing the information representing the user-input to a computing device associated with scheduling appointments related to the sponsored content item. The information is used by the computing device to schedule the appointment.

Implementations of the above aspects can include one or more of the following.

An indication whether the appointment is confirmed can be received from the computing device, and information can be provided to the client device in accordance with the same. The information can cause the display of the sponsored content item to be updated in accordance with the indication. A calendar associated with a user of the client device may be accessed and the calendar may be updated in accordance with the indication whether the appointment is confirmed. The form can include a first field for receiving a date and time for the appointment. The form can also include at least a second field for receiving additional information related to scheduling the appointment. A first calendar associated with a user of the client device, and a second calendar associated with a sponsor of the sponsored content item can be accessed, and the set of time slots can be displayed within the sponsored content item as selectable suggestions for scheduling the appointment. The form can include a second control for initiating a transmission of the information representing the user-input from the client device to the one or more computing devices. The indication can indicate a successful confirmation of the appointment, and the information can cause the display of the sponsored content item to be updated with a second control for viewing details related to the appointment. The sponsored content item can be an advertisement.

Particular implementations may realize none, one, or more of the following advantages. A control for scheduling an appointment with a content sponsor can be provided within a corresponding content item. The control can facilitate scheduling an appointment directly from within the content item without the user having to visit additional webpages. Suggested times for scheduling the appointment can be provided by accessing one or more of the content sponsor's calendar and the user's calendar, based on applicable permissions provided by the content sponsor and the user, respectively. A scheduled appointment can be added to the user's calendar and displayed within the content item.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for delivering content.

FIGS. 2A-2D depict examples of user interfaces displayed on a user's device to facilitate scheduling an appointment from within a content item.

FIG. 3 is a schematic diagram illustrating communications between computing devices associated with a content management and delivery system, a user, and a content sponsor.

FIG. 4 is a flowchart of an example process for facilitating scheduling of an interview from within a content item.

FIG. 5 is an example of a computer system on which the processes described herein may be implemented.

Like reference numbers and designations in the various drawings indicate like elements.

### DETAILED DESCRIPTION

Sponsored content, such as advertising, may be provided to user devices based on various parameters such as, demographics, keywords and interest. For example, advertising (an “ad”) may be associated with one or more keywords that are stored as metadata along with the ad. A search engine, which operates on the network, may receive input from a user. The input may include one or more of the keywords. A content management and delivery system, which serves ads, may receive the keywords from the search engine, identify the ad as being associated with one or more of the keywords, and output the ad to the user, along with content that satisfies the initial search request. The content that satisfies the initial search request is often referred to as the organic search results, and can be distinguished from sponsored content (e.g. the ads) provided therewith. The organic and sponsored content are displayed on a computing device. When displayed, the sponsored content can be incorporated into an appropriate slot on the results page. The user may select the ad by clicking on the ad. In response, a hyperlink associated with the ad can direct the user to another web page. For example, if the ad is for a car company such as Goodbuy Cars, the web page to which the user is directed may be the home page for Goodbuy Cars. This activity is known as click-through. In this context, a “click” is not limited to a mouse click, but rather may include a touch, a programmatic selection, or any other interaction by which the ad may be selected.

In some implementations, a sponsored content item may include multiple hyperlinks that allow a user to directly access various webpages associated with the content sponsor without having to go through the home page. For example, a user clicking on an advertisement from a car servicing company may be interested in scheduling an appointment with the company. In some cases, the advertisement from the company can be configured to include a hyperlink that takes the user to a scheduling webpage where the user can specify various details (e.g., preferred time, make and model of car, mileage, problem etc.) to initiate scheduling an interview. In such cases the user may click on multiple hyperlinks and navigate away from the search results page before discovering that an appointment is not available, or the times at which an appointment is available, is not convenient. The user may then have to navigate back to the search results page before trying to schedule an appointment elsewhere.

In some implementations, a content item can be configured to include a control (e.g., a button or hyperlink) that launches a scheduler extension which allows an appointment to be scheduled from within the content item. For example, a user can use the control to request an appointment, and receive an indication whether the appointment is successfully scheduled, from within an advertisement. The control, and the corresponding scheduler extension allows for scheduling an appointment quickly, and without having to navigate away from the search result page on which the content item is displayed, thereby improving user experience related to interactions with sponsored content items.

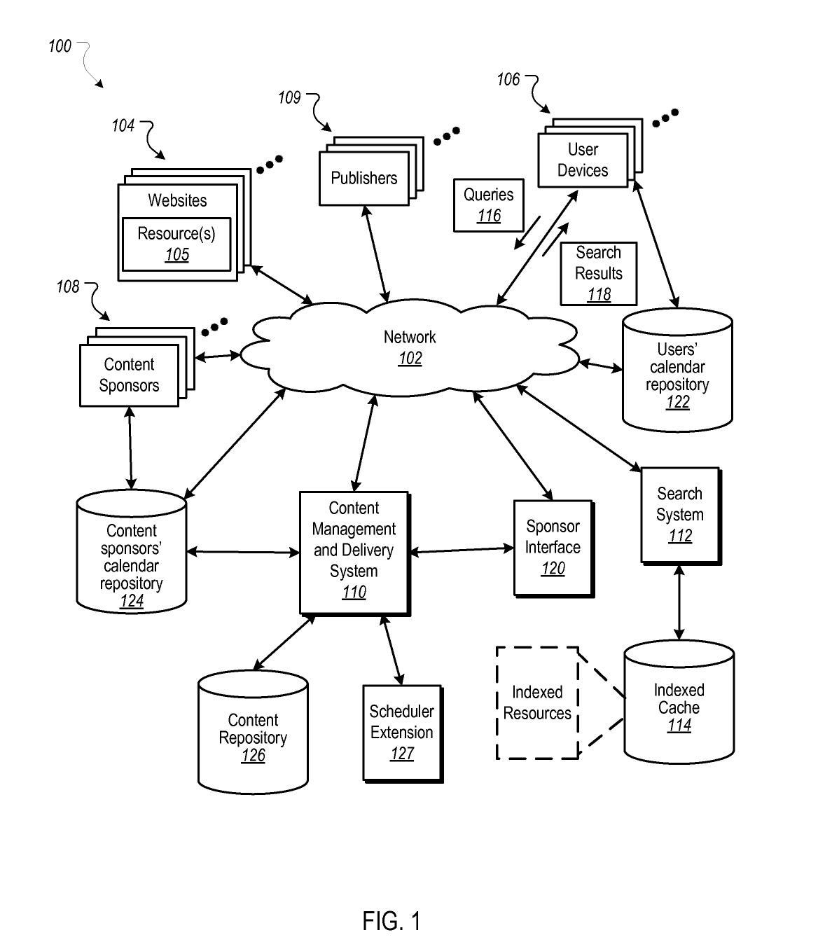

FIG. 1 is a block diagram of an example environment 100 for delivering content in accordance with the methods and systems described in this document. The example environment 100 includes a content management and delivery system 110 for selecting and providing content to user devices. The example environment 100 includes a network 102, such as a local area network (LAN), a wide area network (WAN), the Internet, or a combination thereof. The network 102 connects websites 104, user devices 106, content sponsors 108 (e.g., advertisers), content publishers 109, and the content management and delivery system 110. The example environment 100 may include many thousands of websites 104, user devices 106, content sponsors 108 and content publishers 109. A content repository 126 can store content items that are created by content sponsors 108. For example, the content items can include advertisements or other sponsored contents each of which may be associated with one or more keywords.

In some implementations, the content management and delivery system 110 includes a request handler that can receive a request for content (e.g. a resource 105) from a user, identify one or more eligible content items or resources 105, and provide a content item or resource 105 responsive to the request. For example, the content management and delivery system 110 can be configured to provide organic search results and/or sponsored content items in response to one or more search terms provided by a user through a user device 106. In some implementations, the content management and delivery system 110 can deliver sponsored content to user devices 106 responsive to a request for displaying a website. The content management and delivery system 110 can be configured to select sponsored content items to provide alongside the organic search results or websites requested from user devices 106. The content management and delivery system 110 can be configured to select sponsored content items such that the likelihood of the sponsored content items being clicked is high, for example, above a predetermined threshold value. For example, if delivering a particular ad (with a scheduler extension) to a user group that has previously demonstrated interest in directly scheduling appointments from ads, is likely to lead to a click (or another type of conversion), the ad can be delivered to that user group, but suppressed for others. In some cases, if the ad is delivered to a user group that has not demonstrated interest in directly scheduling appointments from ads, the ad can be delivered without the scheduler extension.

A website 104 can include one or more resources 105 associated with a domain name and hosted by one or more servers. An example website is a collection of web pages formatted in hypertext markup language (HTML) that can contain text, images, multimedia content, and programming elements, such as scripts. Each website 104 can be maintained by a content publisher 109, which is an entity that controls, manages and/or owns the website 104. In some implementations, a content publisher 109 can have one or more slots or positions within a website for displaying sponsored contents. The content publisher 109 can sell the slots (for example, via an auction) to content sponsors 108 (e.g., advertisers) for displaying sponsored contents within the slots.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name a few. The resources can include content, such as words, phrases, images, video and sounds, that may include embedded information (such as meta-information hyperlinks) and/or embedded instructions (such as JavaScript scripts). In some implementations, the resources 105 can include sponsored content provided by the content sponsors 108. For example, the resources 105 can include an advertisement, a deal or a special offer sponsored by a content sponsor 108. In some implementations, a resource 105 is a content item that includes a control for launching a scheduler extension 127 that allows for scheduling an appointment from within the content item. In some implementations, a resource 105 can include search results 118 that are generated in response to one or more queries 116 provided by a user.

A user device 106 is an electronic device that is under control of a user and is capable of requesting and receiving resources 105 over the network 102. Example user devices 106 include personal computers, televisions with one or more processors embedded therein or coupled thereto, set-top boxes, mobile communication devices (e.g., mobile devices such as smartphones, tablet computers, e-readers, laptop computers, personal digital assistants (PDA)), and other devices that can send and receive data over the network 102. A user device 106 typically includes one or more user applications, such as a web browser, to facilitate the sending and receiving of data over the network 102. In some implementations, the user device 106 can be configured to execute applications that are configured to receive/generate/manage sponsored or other content items from the content management and delivery system 110. In some implementations, such applications can include third-party applications and can be downloaded to the user device 106 from an applications repository. In some implementations, the content management and delivery system 110 can be configured to deliver content items (e.g., ads) to a third party application executing on a user device 106.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or web page, in which content can be presented. These specified portions of the resource or user display are referred to as slots (e.g., ad slots).

To facilitate searching of these resources, the environment 100 can include a search system 112 that identifies the resources by, for example, crawling and indexing the resources provided by the content publishers on the websites 104. Data about the resources can be indexed based on the resource to which the data corresponds. The indexed (and, optionally, cached) resources can be stored in an indexed cache 114.

User devices 106 can submit search queries 116 to the search system 112 over the network 102. In response, the search system 112 accesses the cache 114 or index to identify resources that are relevant to the search query 116. The search system 112 identifies the resources in the form of search results 118 and returns the search results 118 to the user devices 106 in search results pages. A search result 118 can include organic search result data generated by the search system 112 that identifies a resource 105 responsive to a particular search query, and includes a link to the resource 105. In some implementations, the content management and delivery system 110 can generate the search results 118 using information (e.g., identified resources) received from the search system 112. An example search result 118 can include a web page title, a snippet of text or a portion of an image extracted from the web page, and the URL of the web page. Search results pages can also include one or more slots in which sponsored content items (e.g., ads) can be presented. In some implementations, slots on search results pages or other web pages can include content slots for content items that have been provided as part of a reservation process. In a reservation process, a publisher and a content item sponsor enter into an agreement where the publisher agrees to publish a given content item in accordance with a schedule (e.g., provide 1000 impressions by date X) or other publication criteria.

When a resource 105, search results 118 and/or other content are requested by a user device 106, the content management and delivery system 110 can select content items that are eligible to be provided in response. For example, the content management and delivery system 110 can select one or more sponsored content items that are served along with search results 118, in response to a user query 116. In some implementations, the content management and delivery system 110 can be configured to select the sponsored content item based on a parameter representing an estimated effectiveness of the sponsored content item to trigger a conversion or click associated with the sponsored content item.

In some cases, the effectiveness of a sponsored content item can be improved by configuring the content item to include a control that allows directly scheduling an appointment from within the content item. For example, ads related to certain categories or industries (e.g., ads related to car servicing, dentists, doctors, other medical facilities, pet grooming, or restaurants) can be made more effective by providing controls for scheduling appointments from within the ads. In some implementations, when a content sponsor 108 provides a sponsored content item to the content management and delivery system 110 (e.g., via a sponsor interface 120), the content management and delivery system 110 may provide an option of including a scheduling control within the sponsored content item. The option can be provided, for example, upon identifying, for example, a category of the content item, a product or service related to the content item, or an existence of a scheduling webpage related to the corresponding content sponsor. In some implementations, the option can be provided to all content sponsors without making any assumptions or determinations with respect to the corresponding sponsored content items.

The content management and delivery system 110 can select from the eligible content items that are to be provided to the user device 106 based at least in part on results of an auction (or by some other selection process). For example, for the eligible content items, the content management and delivery system 110 can receive offers from content sponsors 108 and allocate or prioritize delivery of the content items, based at least in part on the received offers (e.g., based on the highest bidders at the conclusion of the auction or based on other criteria, such as those related to satisfying open reservations).

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a web page, and consummates a purchase there before leaving that web page. A conversion can also be defined by a content provider to be any measurable/observable user action, such as scheduling an appointment, downloading a white paper, initiating a phone call, navigating to at least a given depth of a website, viewing at least a certain number of web pages, spending at least a predetermined amount of time on a web site or web page, registering on a website, signing up for a newsletter, experiencing media, or performing a social action regarding a content item (e.g., an ad), such as republishing or sharing the content item. In some implementations, providing a control that allows a user to schedule an appointment from within a content item increases the likelihood of conversion for the content item, making such a control valuable to the content sponsors.

In some implementations, the likelihood that a conversion will occur can be improved, such as by providing a control that allows a user to schedule an appointment from within a content item. For example, if a user is searching for pet-grooming centers, the user may be more interested in an ad that includes a control for scheduling an appointment directly from within the ad, than in an ad that does not include such a control. The likelihood of conversion can be increased further, for example, by providing additional functionalities associated with the control or the scheduler extension 127 triggered by the control. In some implementations, the scheduler extension 127 can be configured such that when a user initiates an appointment request using the control, the content management and delivery system 110 provides suggested time slots based on, for example, the user's preferences. For example, the user may allow the content management and delivery system 110 to access the user's calendar (which is stored, for example, in a users' calendar repository 122) and the content management and delivery system 110 can then suggest one or more free time slots based on information from the user's calendar. In some implementations, the content management and delivery system 110 may also have access to the content sponsor's calendar (which is stored, for example, in a content sponsors' calendars repository 124), and can then suggest time slots based on information from both the user's calendar and the content sponsor's calendar. A content sponsor can be asked to provide access to a corresponding calendar (e.g., via the sponsor interface 120) if the content sponsor chooses to include a scheduling control within a sponsored content item.

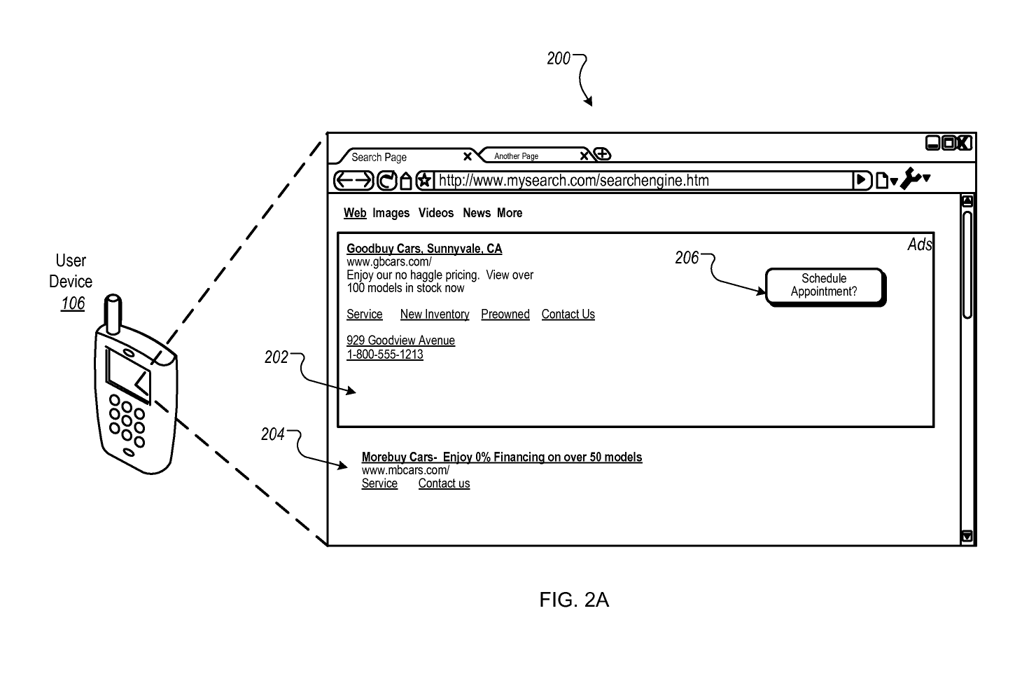

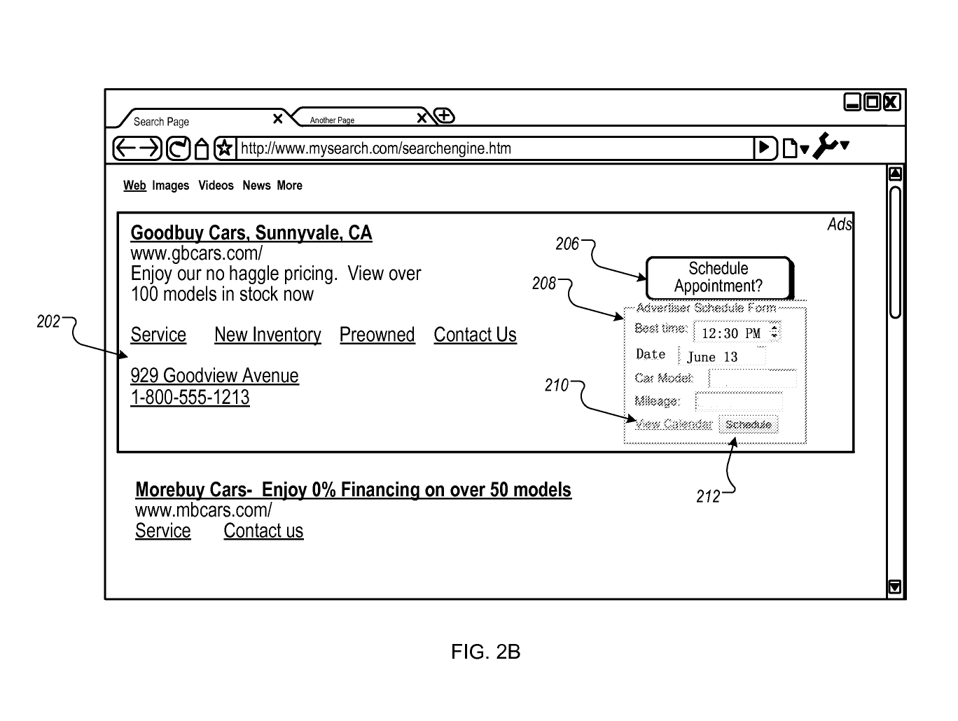

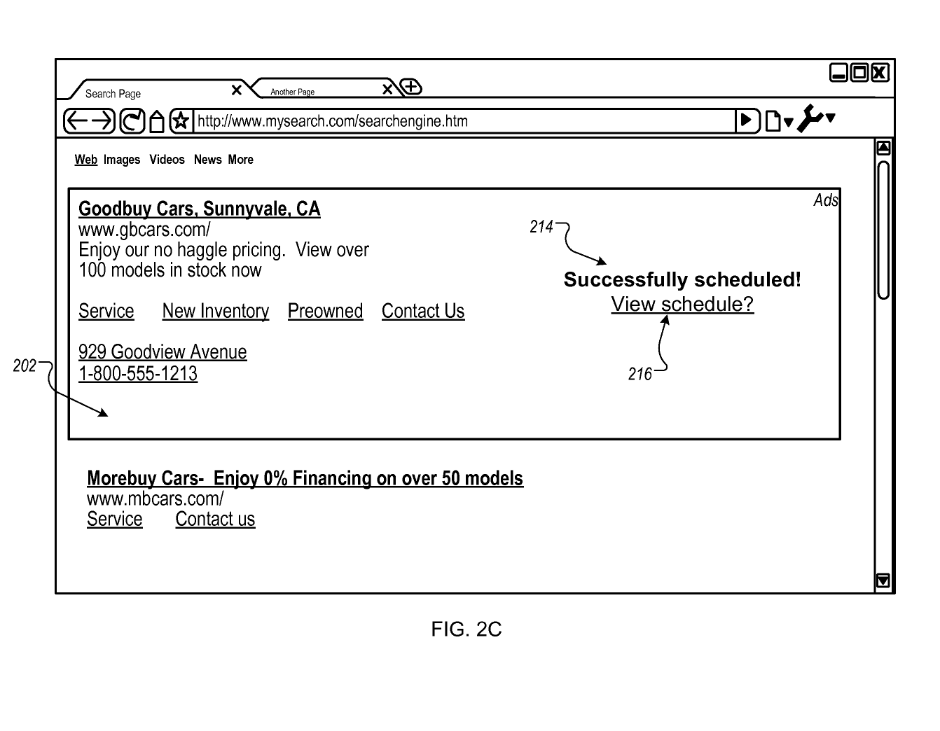

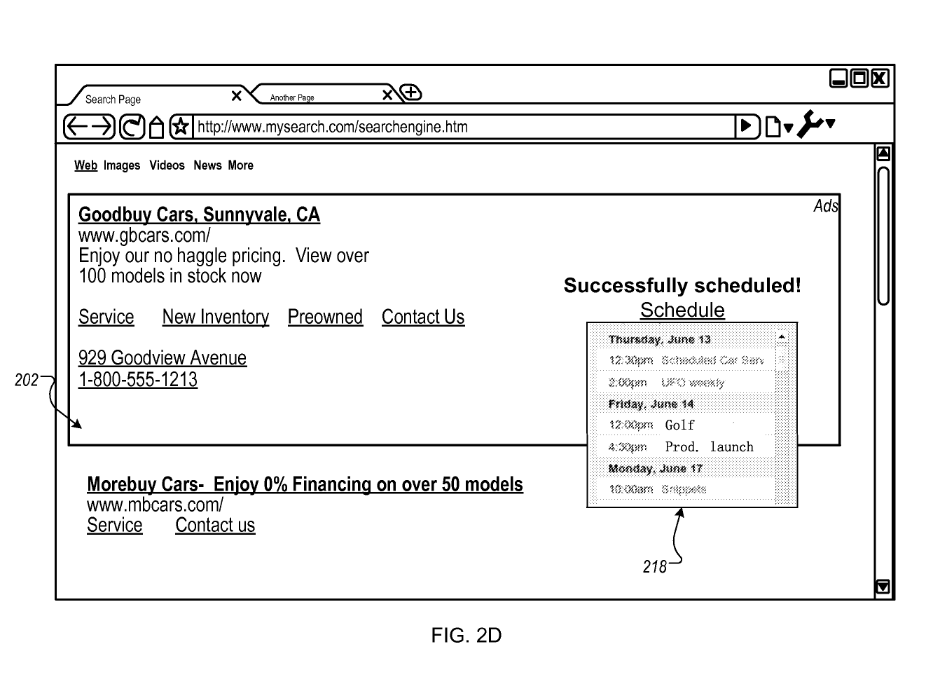

FIGS. 2A-2D are block diagrams depicting examples of user interfaces displayed on a user device 106 to facilitate scheduling an appointment from within a content item. For example, FIG. 2A depicts a browser based user interface 200 where an ad 202 is displayed as a sponsored content item alongside organic search results 204. Even though the examples of FIGS. 2A-2D include browsers, the user interfaces can also be displayed, for example, within browser-independent applications. For example, the user interfaces illustrated in FIGS. 2A-2D can be displayed within a browser-independent application dedicated to searching the Internet. The ad 202 includes a control 206 that allows a user of the user device 106 to schedule an appointment with the content sponsor (Goodbuy Cars, in this example) directly from within the ad 202. The control 206 can be a graphical button 206 (as shown in the example of FIG. 2A), a hyperlink, an icon or any other user selectable representation. In some implementations, the control 206, when activated or selected by a user (e.g., via a mouse click), launches a scheduler extension that allows an appointment to be scheduled directly from within the ad 202.

Referring to FIG. 2B, in some implementations, when the control 206 is selected, the scheduler extension causes the display of a form 208 within the ad 202. The form 208 can be used to receive user-input related to the appointment that the user wishes to schedule. For example, the form 208 can include one or more fields in which the user can input a preferred time and date for the appointment. In some implementations, the form 208 includes a control (e.g., a hyperlink) 210 that allows access to the user's calendar. The user can then view and/or select an available time slot to specify a preferred time for the appointment. In some implementations, the form 208 can be configured to display available time slots based on availability information from the corresponding content sponsor's calendar. The user can then choose a time slot based on, for example, information from the user's calendar as well as the content sponsor's calendar. In some implementations, when both the user and the content sponsor have provided the content management and delivery system 110 access to the respective calendars, the scheduler extension can display within the form 208, the time slots corresponding to overlapping availability. The scheduler extension can also be made smarter such that the suggested time slots displayed within the form 208 is based on additional information that the scheduler extension might access. For example, if a user provides the content management and delivery system 110 access to historical data associated with the user's calendar, the scheduler extension can be configured to suggest time slots for a dental appointment, based on, for example, an analysis of time slots at which the user has historically scheduled dental appointments. One or more machine learning processes can be used to analyze the information available in the user's calendar, based on the level of permission provided by the user.

The form 208 can also include one or more fields for receiving user input that can be used in scheduling an interview. The example of FIG. 2B shows that the form 208 includes fields for receiving user-input related to a model of a car for which service is requested, and the mileage or odometer reading of the car. The additional information requested from the user via the form 208 may be specified by the content sponsor when opting for the scheduler control within a sponsored content item. For example, a medical facility may request the user to input an identification number, such that the facility may locate the records for the user. In another example, a car servicing facility may request a brief description of the service sought, such that the appointment can be scheduled in accordance with the availability of a suitable technician.

The form 208 can also include a control 212 that initiates transmission of the user-input to the content management and delivery system 110. When a user selects the control 212, the information provided via the fields within the form 208 can be transmitted to the content management and delivery system 110 such that the content management and delivery system 110 can forward the information to the content sponsors. Activating the control 212 can cause, for example, the information based on the user-input to be provided to one or more computing devices (e.g., a server) responsible for scheduling appointments for the content sponsor. The computing devices can determine, based on the information, whether an appointment can be scheduled or not, and provide an indication to the content management and delivery system 110 in accordance with the same. For example, if a server responsible for scheduling the appointments determines that an interview can be successfully scheduled, the server updates the content sponsor's calendar accordingly and sends an indication to the content management and delivery system 110 that the appointment has been successfully scheduled. The content management and delivery system 110, in turn, sends an update to the user device such that the display of the sponsored content item on the user device is updated to reflect the successful scheduling of the appointment.

FIG. 2C shows an example of an updated display of the sponsored content item 202. In this example, an appointment has been successfully scheduled and the sponsored content item 202 is therefore updated with an indication 214 to reflect the successful scheduling. In some implementations, the sponsored content item 202 can also be updated to include a control 216 that allows the user to view the scheduled appointment in a calendar associated with the user. For example, if the user provides the appropriate permissions, the content management and delivery system 110 can be configured to populate the user's calendar with the scheduled appointment, and make at least a portion of the calendar available via the control 216 provided within the sponsored content item 202. An example of this is shown in FIG. 2D, wherein an activation of the control 216 causes the display of the sponsored content item to be updated with a representation 218 of the user's calendar. In some implementations, activation of the control 216 can cause the user's calendar to be displayed separately, for example, within a separate application or a separate tab of the browser. As described above with reference to the examples in FIGS. 2A-2D, in some implementations, the user is able to initiate scheduling an appointment, receive a confirmation, and view the scheduled appointment all from within a sponsored content item 202 without having to navigate to any additional webpages.

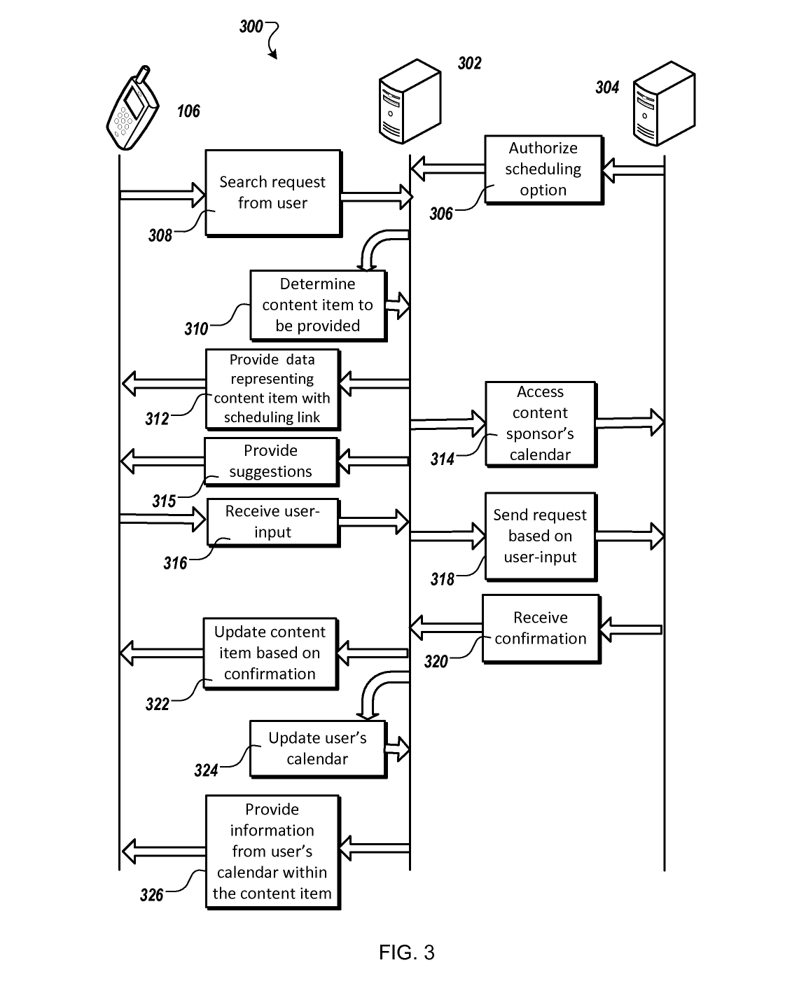

FIG. 3 is a schematic diagram illustrating an example sequence 300 of communications between a server 302 associated with the content management and delivery system 110, a user device 106, and a computing device 304 that handles scheduling of appointments for a content sponsor 108. In some implementations, the computing device 304 can include a server that facilitates scheduling of appointments for the content sponsor. In the example depicted in FIG. 3, an authorization 306 allows for a scheduling option to be included within a sponsored content item provided by the content sponsor. The authorization 306 can be received, for example, from the computing device 304. The authorization 306 can be provided, for example, via a sponsor interface (e.g., the sponsor interface 120 described with reference to FIG. 1) that the content sponsor uses for interacting with the content management and delivery system. The authorization 306 can be provided by the content sponsor in response to a request from the content management and delivery system through the sponsor interface. In some implementations, the authorization 306 can include a permission to access one or more calendars associated with the content sponsor. For example, the authorization 306 may allow the server 302 to access a scheduling calendar of the content sponsor for the purpose of providing scheduling suggestions to a user.

In some implementations, a request for content (e.g., a search request 308) can be received at the server 302. For example, the search request 308 can be received from the user device 106. A determination 310 with respect to a content item to be provided can then be made. For example, the server 302 can decide that a content item provided by the content sponsor associated with the computing device 304 is to be provided to the user device 106. In some implementations, the determination 310 can be made, for example, based on matching one or more search terms associated with the search request 306 to a keyword associated with the content item provided by the content sponsor. The determination 310 can also be made independent of the search request 308. The determination 310 can include a decision to provide, within the content item, a control (e.g., a link, or a button) for scheduling appointments.

Data 312 representing the content item with the scheduling link can then be provided, for example by the server 302 to the user device 106. The data 312 can cause a display of the content item on the user device 106 such that a user of the device 106 can activate the scheduling control displayed within the control item to initiate a process of scheduling an appointment with the content sponsor. Upon receiving an indication that the user has initiated the process of scheduling the appointment, an access request 314 to access a scheduling calendar of the content sponsor can be transmitted. For example, the server 302 can transmit the access request 314. The access request can be sent to the computing device 304, or to another device that controls access to the calendar. The content sponsor's calendar can be stored as a part of a database on a storage device that the server 302 can access.

Based on the content sponsor's calendar information accessed via the request 314, one or more suggestions 315 related to scheduling of the appointment may be provided. For example, the server 302 may provide one or more suggested time slots to the user device 106. In some implementations, the server 302 may retrieve information related to time slots that the content sponsor has available for scheduling the appointment, and provide the suggestions 315 based on such information. In some implementations, the suggestions 315 can also be provided based on availability information retrieved from a calendar of the user, if the user has provided the server 302 access to such information. For example, the suggestions 315 can include multiple time slots that are based on availability information from the content sponsor's calendar, but some of the multiple time slots may be filtered out from being displayed based on, for example, information about the user's calendar available. This allows for time slots that work for both the user and the content sponsor to be displayed as suggestions within the content item displayed on the user device 106. The suggestions 315 can also be based on, for example, information derived by executing one or more machine learning processes on historical calendar data available for the user. Historical calendar data for the user may be accessed and used for the suggestions 315 if the user has provided access to such data. The suggestions 315 can be displayed within the content item displayed on the user device 106, for example, as a portion of the form 208 described with reference to FIG. 2B.

In some implementations, the appointment may be scheduled based on received user-input 316. For example, the user device 106 can be configured to transmit the user-input 316 related to the appointment to the server 302. The user input 316 can include, for example, one or more time slots proposed by the user for the appointment. The user input 316 can also include additional information (e.g., as described with reference to FIG. 2B) that may be used for scheduling the appointment. Based on the user-input 316, an appointment request 318 may be issued. For example, the server 312 can send the request 318 to the computing device 304, requesting that an appointment be scheduled based on the user input 316.

The request 318 may be analyzed to determine whether an appointment can be scheduled based on the information provided by the user. For example, the computing device 304 can analyze the request 318, and then send an indication to the server 302 whether the appointment has been scheduled. A confirmation 320 related to the appointment can be issued accordingly. For example, if the computing device 304 determines that an appointment can be scheduled in accordance with the request 318, the computing device may update the content sponsor's calendar accordingly, and send the confirmation 320, which is received at the server 302. Information 322 to update the content item may be transmitted accordingly. For example, the server 302 may transmit the information 322 to the user device 106, such that the information 322 causes the display of the content item on the user device to be updated in accordance with the confirmation 320.

In some implementations, an update 324 to the user's calendar may be performed to reflect scheduling of the appointment. For example, if the user has provided the server 302 an access to the user's calendar, the server 302 may perform an update 324 on the user's calendar in accordance with the received confirmation 320. In some implementations, information 326 reflecting the update to the user's calendar may be transmitted. For example, the server may provide the information 326 to the user device 106, such that the content item on the user device is updated to display at least a portion of the user's calendar within the content item. The display can appear, for example, as shown in the example illustrated in FIG. 2D.

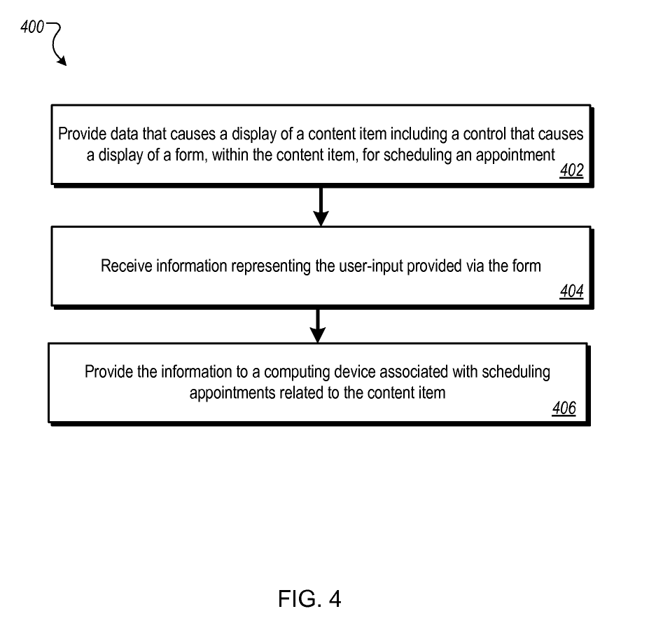

FIG. 4 is a flowchart of an example process 400 for facilitating scheduling of an interview from within a content item. The process 400 can be performed by the content management and delivery system 110, for example, using a server 302 described with reference to FIG. 3. Operations can include providing, from the server, data that causes a display of a content item on a user device (402). The content item includes a control that, upon activation, causes a display of a form for scheduling an appointment. The form is displayed within the content item such that a user activating the control does not have to navigate to another page to schedule the appointment, but can do so from within the content item. The content item can be a sponsored content item such as an ad which is provided from a pool of sponsored content items, for example, in response to a request for content received from a user device.

The form that is displayed within the content item upon activation of the control can be used for receiving user-input (e.g., a preferred time) related to scheduling the appointment. For example, the form can include one or more fields for receiving a date, a time, and other relevant information pertaining to the appointment. The form can also include one or more suggestions that the user may select via the form. The suggestions can be substantially similar to the suggestions 315 described above with reference to FIG. 3.

Operations also include receiving at the server, information that represents the user-input provided by the user via the form (404). In some implementations, the information can be received at the server when a user activates a control from within the form to initiate a transmission of the user input from the user's device.

Operations further include providing the information to a computing device associated with scheduling appointments related to the content item (406). For example, when the content item is an ad for a medical facility, the information can include an appointment request which is based on the user-input, and is provided to a server that handles scheduling of appointments for the medical facility. The computing device can then use the information to schedule the appointment requested by the user.

In response to the information provided, the computing device may provide an indication whether the appointment is confirmed. In some implementations, the indication is provided to the client device such that a display of the content item can be updated in accordance with the indication. For example, an ad from which the appointment request is initiated may be updated to display that the appointment has been successfully scheduled. In some implementations, the computing device may provide the indication in other ways. For example, the computing device may generate an e-mail, text message, or instant message that is sent to the requester based on contact information provided by the user as a part of the user-input. In some implementations, the computing device may also forward the indication to a human operator who may then contact the requester, for example, to request additional information or confirm the appointment. The indication provided by the computing device can include a status indicator related to the appointment. For example, the status indicator may reflect that the appointment request is under review and that the requester will receive an e-mail when the appointment is confirmed. In some implementations, the information that causes the display of the content item on the client device to be updated can cause a display of a control that enables the user to view the details of the appointment from within the content item. For example, the display of the content item can be updated to include a link that displays the scheduled appointment on a portion of a calendar.

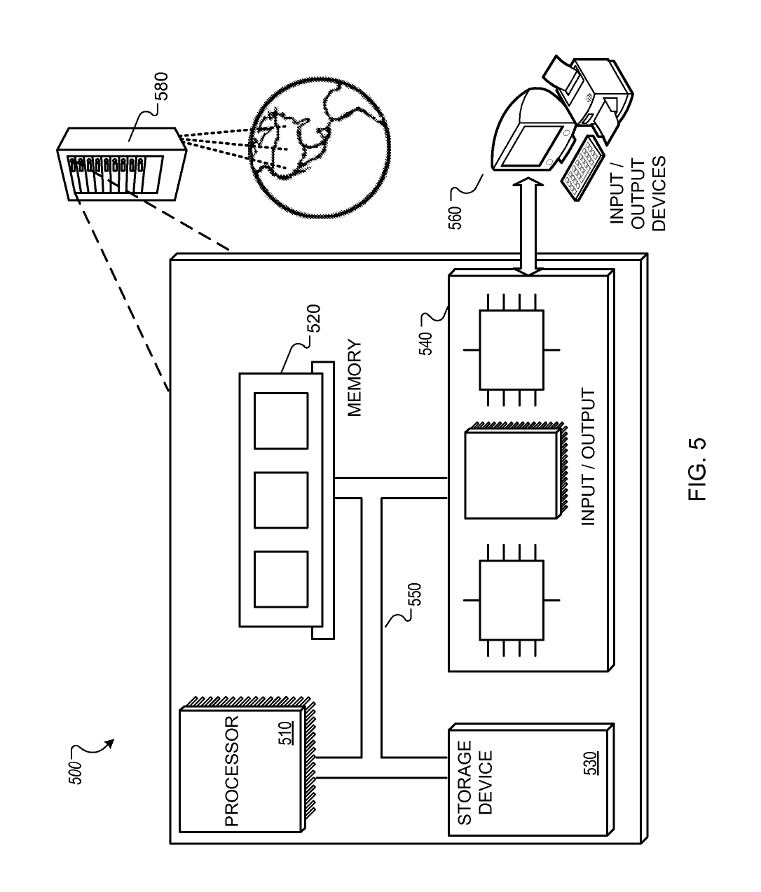

FIG. 5 is block diagram of an example computer system 500 that may be used in performing the processes described herein. For example, the content management and delivery system 110, the content repository 126, the scheduler extension 127, the user device 106, the server 302, or the computing device 304, described above with reference to FIGS. 1 and 3, can include at least portions of the computing device 500 described below. Computing device 500 is intended to represent various forms of digital computers, such as laptops, desktops, workstations, servers, blade servers, mainframes, and other appropriate computers. Computing device 500 is further intended to represent various typically non-mobile devices, such as televisions or other electronic devices with one or more processers embedded therein or attached thereto. Computing device 500 also represents mobile devices, such as personal digital assistants, touchscreen tablet devices, e-readers, cellular telephones, smartphones.

The system 500 includes a processor 510, a memory 520, a storage device 430, and an input/output module 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, or some other large capacity storage device. The storage device 530 can be used to implement, for example, the content repository 126, the user's calendar repository 122, or the content sponsors' calendar repository 124.

The input/output module 540 provides input/output operations for the system 500. In one implementation, the input/output module 540 can include one or more of a network interface devices, e.g., an Ethernet card, a serial communication device, e.g., an RS-232 port, and/or a wireless interface device, e.g., and 802.11 card. In another implementation, the input/output device can include driver devices configured to receive input data and send output data to other input/output devices, e.g., keyboard, printer and display devices 560.

The web server, advertisement server, and impression allocation module can be realized by instructions that upon execution cause one or more processing devices to carry out the processes and functions described above. Such instructions can comprise, for example, interpreted instructions, such as script instructions, e.g., JavaScript or ECMAScript instructions, or executable code, or other instructions stored in a computer readable medium. The web server and advertisement server can be distributively implemented over a network, such as a server farm, or can be implemented in a single computer device.

Example computer system 500 can include a server. Various servers, which may act in concert to perform the processes described herein, may be at different geographic locations, as shown in the figure. The processes described herein may be implemented on such a server or on multiple such servers. As shown, the servers may be provided at a single location or located at various places throughout the globe. The servers may coordinate their operation in order to provide the capabilities to implement the processes.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible program carrier, for example a non-transitory computer-readable medium, for execution by, or to control the operation of, a processing system. The non-transitory computer readable medium can be a machine readable storage device, a machine readable storage substrate, a memory device, or a combination of one or more of them.

In this regard, various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Content, such as ads and GUIs, generated according to the processes described herein may be displayed on a computer peripheral (e.g., a monitor) associated with a computer. The display physically transforms the computer peripheral. For example, if the computer peripheral is an LCD display, the orientations of liquid crystals are changed by the application of biasing voltages in a physical transformation that is visually apparent to the user. As another example, if the computer peripheral is a cathode ray tube (CRT), the state of a fluorescent screen is changed by the impact of electrons in a physical transformation that is also visually apparent. Moreover, the display of content on a computer peripheral is tied to a particular machine, namely, the computer peripheral.

For situations in which the systems and methods discussed here collect personal information about users, or may make use of personal information, the users may be provided with an opportunity to control whether programs or features that may collect personal information (e.g., information about a user's calendar, social network, social actions or activities, a user's preferences, or a user's current location), or to control whether and/or how to receive content from the content management and delivery system 110 that may be more relevant to (or likely to be clicked on by) the user. In addition, certain data may be anonymized in one or more ways before it is stored or used, so that personally identifiable information is removed when generating monetizable parameters (e.g., monetizable demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by the content management and delivery system 110.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. For example, the methods and systems described in this document can be used, at least in part, to select and price ads that are to be displayed on an electronic billboard at a given time, for example, a particular time of the day. Similarly, the described methods and systems can be used, at least in part to select ads to be printed in a newspaper in a certain month or season. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by one or more processing devices, the method comprising:
providing, from the one or more processing devices, data that causes a display of a sponsored content item on a client device, wherein the sponsored content item is provided from a pool of sponsored content items in response to a request for content received from the client device, and the display of the sponsored content item includes a control for scheduling an appointment, and wherein the control, responsive to an input, causes a display of a form within the content item for receiving user-input related to scheduling the appointment;
receiving, at the one or more processing devices, information representing the user-input related to scheduling the appointment; and
providing the information representing the user-input to a computing device associated with scheduling appointments related to the sponsored content item, the information being for use by the computing device to schedule the appointment.

2. The method of claim 1, further comprising:
receiving, from the computing device, an indication whether the appointment is confirmed; and
providing, to the client device, information that causes the display of the sponsored content item to be updated in accordance with the indication.

3. The method of claim 2, further comprising:
accessing a calendar associated with a user of the client device; and
updating the calendar in accordance with the indication whether the appointment is confirmed.

4. The method of claim 1, wherein the form comprises a first field for receiving a date and time for the appointment.

5. The method of claim 4, wherein the form comprises at least a second field for receiving additional information related to scheduling the appointment.

6. The method of claim 1, further comprising:
accessing a first calendar associated with a user of the client device;
accessing a second calendar associated with a sponsor of the sponsored content item;
determining, based on availability information from the first and second calendars, a set of time slots when the appointment can be scheduled; and
displaying the set of time slots within the sponsored content item, as selectable suggestions for scheduling the appointment.

7. The method of claim 1, wherein the form comprises a second control for initiating a transmission of the information representing the user-input from the client device to the one or more computing devices.

8. The method of claim 2, wherein the indication indicates a successful confirmation of the appointment, and the information causes the display of the sponsored content item to be updated with a second control for viewing details related to the appointment.

9. The method of claim 1, wherein the sponsored content item is an advertisement.

10. A system comprising:
a content management and delivery engine comprising at least one processor, configured to:
provide data that causes a display of a sponsored content item on a client device, wherein the sponsored content item is provided from a pool of sponsored content items in response to a request for content received from the client device, and the display of the sponsored content item includes a control for scheduling an appointment, and wherein the control, responsive to an input, causes a display of a form within the content item for receiving user-input related to scheduling the appointment,
receive information representing the user-input related to scheduling the appointment, and
provide the information representing the user-input to a computing device associated with scheduling appointments related to the sponsored content item, the information being for use by the computing device to schedule the appointment; and
a storage device in communication with the content management and delivery engine, the storage device configured to store the pool of sponsored content items.

11. The system of claim 10, wherein the content management and delivery engine is configured to:
receive, from the computing device, an indication whether the appointment is confirmed; and
provide, to the client device, information that causes the display of the sponsored content item to be updated in accordance with the indication.

12. The system of claim 11, wherein the content management and delivery engine is configured to:
access a calendar associated with a user of the client device; and
update the calendar in accordance with the indication whether the appointment is confirmed.

13. The system of claim 10, wherein the form comprises a first field for receiving a date and time for the appointment.

14. The system of claim 13, wherein the form comprises at least a second field for receiving additional information related to scheduling the appointment.

15. The system of claim 10, wherein the content management and delivery engine is also configured to:
access a first calendar associated with a user of the client device;
access a second calendar associated with a sponsor of the sponsored content item;
determine, based on availability information from the first and second calendars, a set of time slots when the appointment can be scheduled; and
cause display of the set of time slots within the sponsored content item, as selectable suggestions for scheduling the appointment.

16. The system of claim 10, wherein the form comprises a second control for initiating a transmission of the information representing the user-input from the client device to the one or more computing devices.

17. The system of claim 11, wherein the indication indicates a successful confirmation of the appointment, and the information causes the display of the sponsored content item to be updated with a second control for viewing details related to the appointment.

18. The system of claim 10, wherein the sponsored content item is an advertisement.

19. A computer-readable storage device having encoded thereon computer readable instructions configured to cause one or more processors to perform operations comprising:
providing data that causes a display of a sponsored content item on a client device, wherein the sponsored content item is provided from a pool of sponsored content items in response to a request for content received from the client device, and the display of the sponsored content item includes a control for scheduling an appointment, and wherein the control, responsive to an input, causes a display of a form within the content item for receiving user-input related to scheduling the appointment;
receiving information representing the user-input related to scheduling the appointment; and
providing the information representing the user-input to a computing device associated with scheduling appointments related to the sponsored content item, the information being for use by the computing device to schedule the appointment.

20. The computer-readable storage device of claim 19 further comprising instructions for:
receiving, from the computing device, an indication whether the appointment is confirmed; and
providing, to the client device, information that causes the display of the sponsored content item to be updated in accordance with the indication.

21. The computer-readable storage device of claim 20, further comprising instructions for:
accessing a calendar associated with a user of the client device; and
updating the calendar in accordance with the indication whether the appointment is confirmed.

22. The computer-readable storage device of claim 19, wherein the form comprises a first field for receiving a date and time for the appointment.

23. The computer-readable storage device of claim 22, wherein the form comprises at least a second field for receiving additional information related to scheduling the appointment.

24. The computer-readable storage device of claim 19, further comprising instructions for:
accessing a first calendar associated with a user of the client device;
accessing a second calendar associated with a sponsor of the sponsored content item;
determining, based on availability information from the first and second calendars, a set of time slots when the appointment can be scheduled; and
displaying the set of time slots within the sponsored content item, as selectable suggestions for scheduling the appointment.

25. The computer-readable storage device of claim 19, wherein the form comprises a second control for initiating a transmission of the information representing the user-input from the client device to the one or more computing devices.

26. The computer-readable storage device of claim 20, wherein the indication indicates a successful confirmation of the appointment, and the information causes the display of the sponsored content item to be updated with a second control for viewing details related to the appointment.

27. The computer-readable storage device of claim 19, wherein the sponsored content item is an advertisement.
